(19) United States
(12) Patent Application Publication
(10) Pub. No.: US 2023/0415530 A1
(43) Pub. Date: Dec. 28, 2023

(54) PROTECTIVE TRAILER BOOT SHEATH COVERING

(71) Applicant: Leslie Bosch, Lake City, FL (US)

(72) Inventor: Leslie Bosch, Lake City, FL (US)

(21) Appl. No.: 18/232,638

(22) Filed: Aug. 10, 2023

Related U.S. Application Data
(60) Provisional application No. 63/351,293, filed on Jun. 10, 2022.

(51) Int. Cl. B60D 1/60

(52) U.S. Cl. CPC B60D 1/605

(57) ABSTRACT

A protective sheath covering for a trailer hitch is disclosed, where the protective sheath provides a T-shaped body that fits over the trailer hitch. The protective sheath may include a hollow shaft to cover the trailer hitch and a solid second portion with a mold fit to receive the trailer hitch.

This application relates to the provisional application U.S. 63/351,293 which was filed on Jun. 10, 2022.

### BACKGROUND OF THE INVENTION

### Technical Field

This invention relates to safety devices for vehicles. In particular, the invention relates to a protective sheath hitching components protector.

Trailer tongue hitching devices are known in the art.

U.S. Pat. No. 5,806,873 describes a trailer tongue cover which encloses the jack mechanism of a trailer.

U.S. Pat. No. 6,322,094 describes a safety cover for a trailer hitch which has a tow ball and a draw bar.

US 2006/0061064 describes a protective cover for a trailer tongue which has an elongated pouch internally sized to receive and encompass the coupler portion and the associated peripheral attachments of a trailer tongue.

However, none of the known art provides ample protection for the entire trailer tongue hitching, including protecting the trailer tongue hitching from exposure to weather elements, nor provide safety features to protect people or surrounding structures from damage from collision with the trailer tongue hitching.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A trailer boot sheath, a trailer hitch protection device, is disclosed, which can be used when trailers are not hooked up and sitting idle or parked. The trailer boot sheath may serve several purposes: (1) The trailer boot sheath protects and cushions vehicles from damage due to impact of the trailer in a driveway or parking lot where parking is limited. The trailer boot sheath protects vehicles from body damage to bumpers, tailgates, grills or other components of a vehicle or when a person overcompensates in judgement when pulling into a driveway to park or backing into a driveway; (2) The trailer boot sheath protects from any physical damage to the human body from impact with the trailer boot sheath, especially lower extremities if working or walking around the trailer, and most importantly protects children from serious injury if running, playing, or riding bicycles around the trailer, be it in the driveway or the yard; (3) the trailer boot sheath protects trailer tongue hitching components, such as a hitch latch, anti-theft locks, safety chains, wiring and lighting hookups, from extreme weather conditions such as rain and extreme summer heat which causes rust and weather-worn brittle wiring which leads to component failure.

A trailer boot sheath includes a first portion covering a trailer hitch and extending outward from the trailer hitch to a location proximal to the trailer hitch, a second portion abutting the first portion at the location proximal to the trailer hitch, where the second portion is connected to the first portion at a substantially perpendicular angle between the first portion and the second portion.

In an embodiment, the trailer boot sheath may have a T-shaped perspective.

In an embodiment, the trailer boot sheath may be covered by or composed of a cushioned material, such as polyurethane foam.

In an embodiment, the second portion is a solid body composed of polyurethane foam, where the second portion has an internal mold fit of the head of the trailer hitch tongue, such that when the second portion is slid on, it prevents the trailer boot sheath from rotating and keeps it in place.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a view of a trailer attachment end.

FIG. 2 is a view of a trailer attachment end with a trailer boot sheath according to the disclosed invention attached to the trailer.

FIG. 3 is a view of the trailer boot sheath, according to the disclosed invention.

FIG. 4 is a view of the trailer boot sheath, according to the disclosed invention.

FIG. 5 is a view of the trailer booth sheath, according to the disclosed invention.

FIG. 6 is a view of the trailer booth sheath, according to the disclosed invention.

FIG. 7 is a view of the trailer booth sheath, according to the disclosed invention.

FIG. 8 is a view of the trailer booth sheath, according to the disclosed invention

### DETAILED DESCRIPTION OF THE PREFERRED EMBODIMENTS

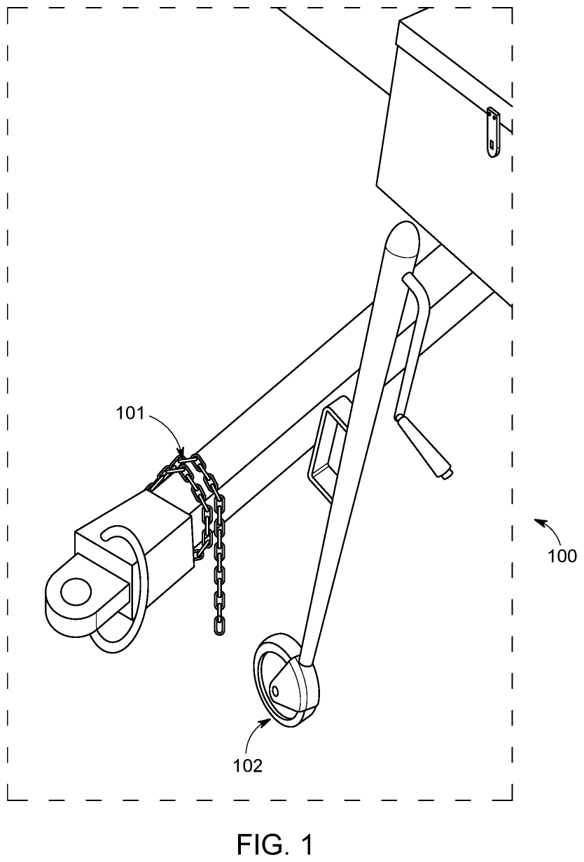

FIG. 1 is a view of a trailer attachment end (100). The trailer attachment end (100) is part of a trailer, where the trailer attachment end (100) is configured to attach to vehicle (not shown here) for transportation. The trailer may include storage modules, equipment or other items that need transportation by a vehicle.

In an embodiment, the trailer attachment end (100) may include hitch latches, anti-theft locks, safety chains, wiring and lighting hookups (101). Other accessories may be possible.

The trailer attachment end (100) may also include a wheel jack (102). The wheel jack (102) may be attached to the trailer attachment end (100) to allow the trailer to be moved about locally and allows the trailer attachment end (100) to be elevated or depressed as needed to attach the trailer attachment end to a vehicle.

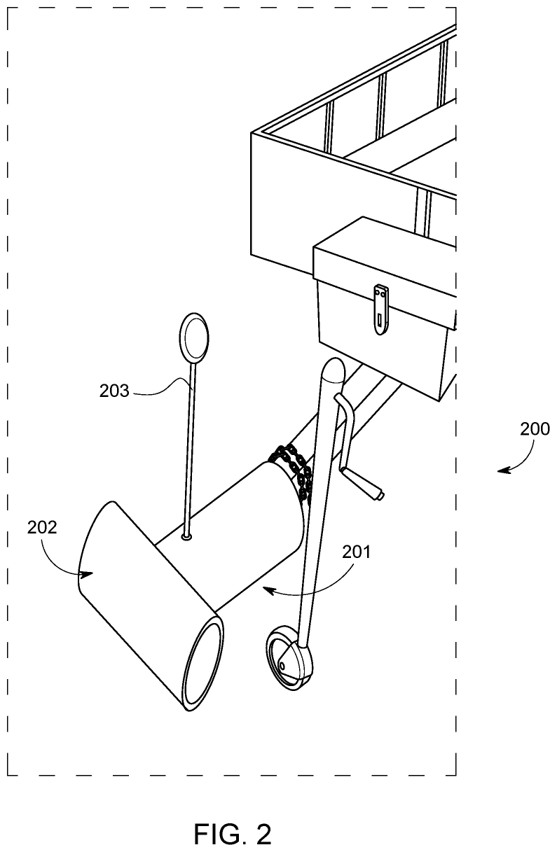

FIG. 2 is a view of a trailer boot sheath (200). The trailer boot sheath (200) is designed to fit over the trailer attachment end (100). The trailer boot sheath (200) may protect the trailer hitch attachment from damaging property, people or other equipment surrounding the trailer attachment end (100). The trailer boot sheath (200) may protect the trailer hitch attachment components, such as a hitch latch, anti-theft locks, safety chains, wiring and lighting hookups (101) from extreme weather conditions such as rain and extreme summer heat which causes rust and weathering worn brittle wiring which leads to component failure. The trailer boot sheath (200) may include other components (203) attachable to a surface of the trailer boot sheath (200).

The trailer boot sheath (200) includes a first portion (201) covering a trailer attachment end (100) and extending outward from the trailer attachment end (100) to a location proximal to the trailer attachment end (100). The first portion (201) is hollow to allow the trailer attachment end (100) to be inserted into the trailer boot sheath (200).

The trailer boot sheath (200) includes a second portion (202) abutting the first portion (201) at the location proximal to the trailer attachment end (100), where the second portion (202) is connected to the first portion (201). In an embodiment of the disclosed invention, the second portion (202) abuts the first portion (201) at a substantially perpendicular angle between the first portion (201) and the second portion (202).

In an embodiment, the second portion (202) is a solid body composed of closed cell polyurethane foam, where the second portion (202) has an internal mold fit of the head of the trailer attachment end, such that when the second portion (202) is slid on, it prevents the trailer boot sheath (200) from rotating and keeps it in place.

The trailer boot sheath (200) may be covered by or made of a cushioned material, such as polyurethane foam, or other materials that are durable but cushiony. In an embodiment, the first portion (201) may be substantially cylindrical in cross-section. In an embodiment, the second portion (202) may also be substantially cylindrical.

Other cross-sectional shapes may be possible. In an embodiment, the trailer boot sheath (200) may have a T-shaped perspective. Other perspective shapes may be employed.

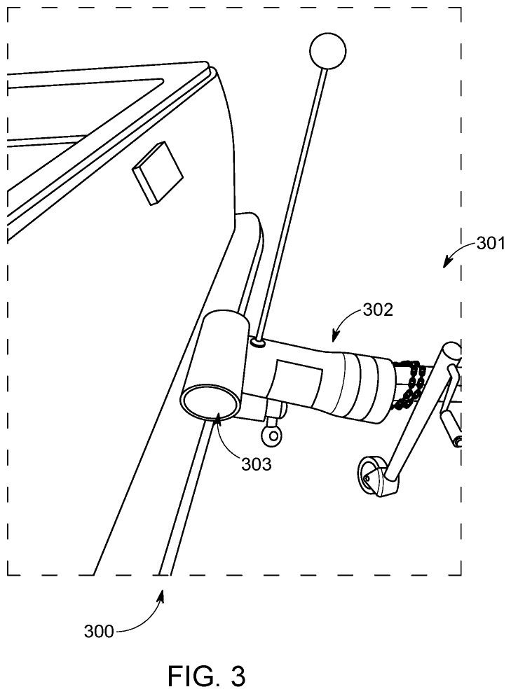

FIG. 3 is another view (300) of a trailer boot sheath (301). The first portion (302) may include a hollow shaft to cover the trailer hitch. The trailer booth sheath (301) may include a solid second portion (303). The solid second portion (303) may include a mold within the solid second portion (303), adapted with a mold fit to receive the trailer tongue, to prevent rotation of the trailer hitch and keep it in place.

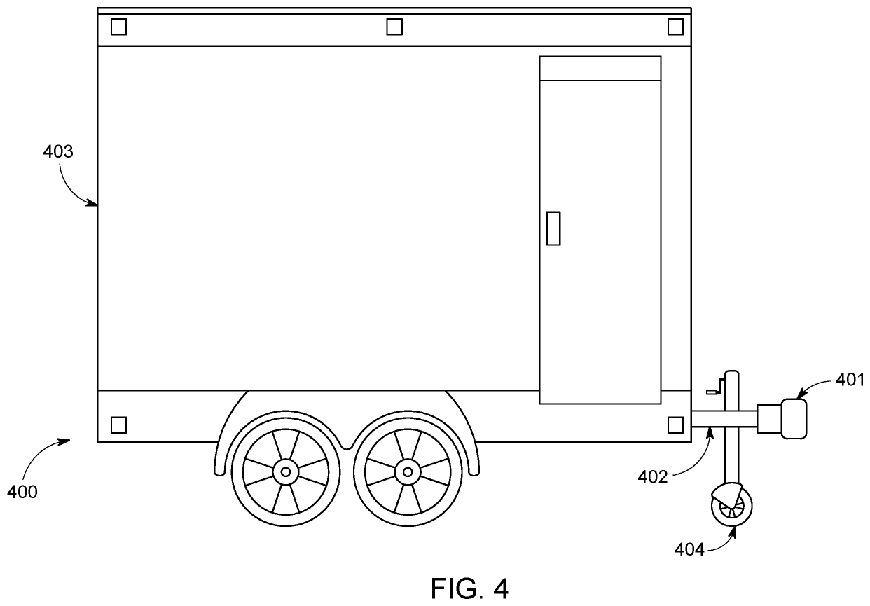

FIG. 4 is a view (400) of a trailer booth sheath, according to the disclosed invention. The trailer boot sheath (401) may be coupled to and covering the trailer hitch attachment (402). The trailer hitch attachment (402) may be coupled to a trailer (403). The trailer (403) may include storage compartments, animal transport equipment or may be a flat-bed trailer. The trailer hitch attachment (402 may include a wheel jack (404) that may allow a user to lower or raise the trailer (403), or move the trailer (403) around a property.

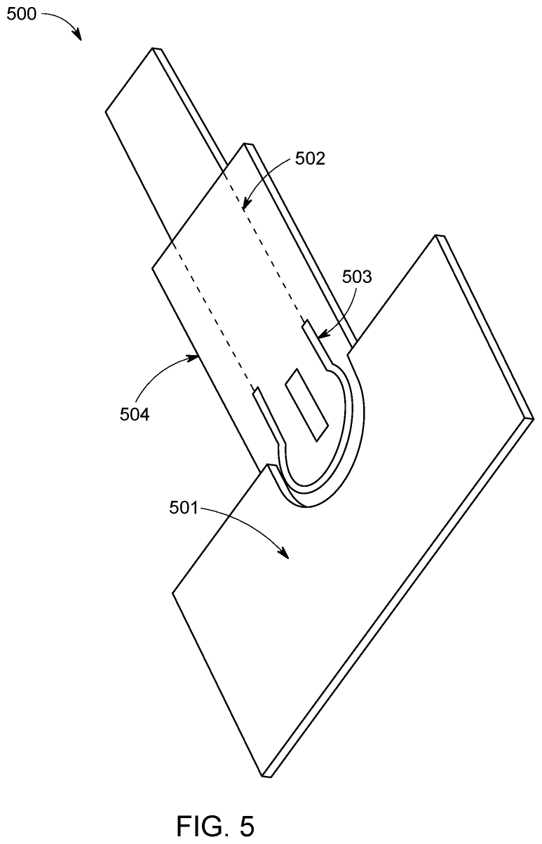

FIG. 5 is a cross-sectional view (500) of the trailer boot sheath according to the disclosed invention. A portion of the trailer boot sheath (500) may include solid member (501). The solid member (501) is coupled to and extends around the end of the trailer hitch attachment (502). The solid member (501) may have a mold fit (503) configured to receive the end of the trailer hitch attachment (502). The solid member (501) may be attached to and abut, in one embodiment, a hollow shaft member (504). Both the solid member (501) and the hollow shaft member (504) may be composed of a durable compound such as polyurethane or other form or material suitable for protecting the trailer hitch attachment (502).

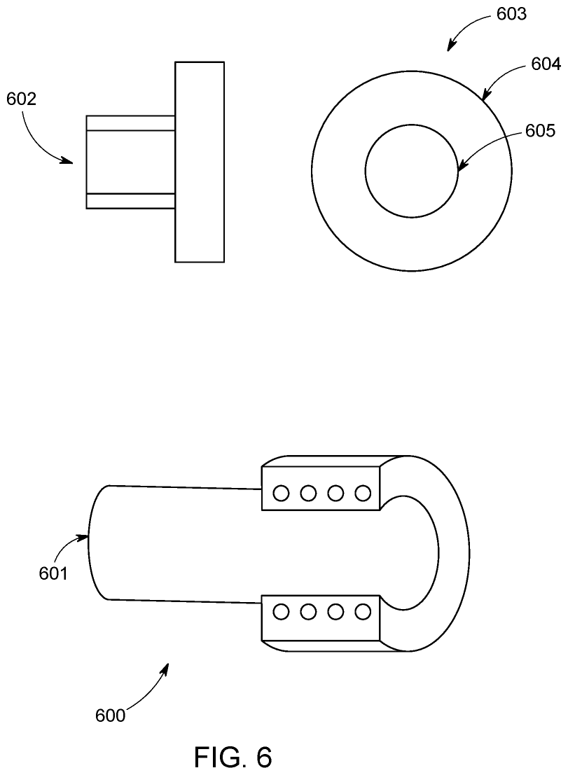

FIG. 6 is a cross-sectional view (600) of a trailer boot sheath (602), according to an embodiment of the disclosed invention. Trailer boot sheath (601) may include a solid member abutting and coupled to a hollow shaft member, with the solid body member having a mold fit within the solid member, configured to receive end of the trailer hitch attachment.

Another cross-sectional view of a trailer boot sheath (602) illustrates that solid member abuts and is coupled with a hollow body member. The trailer boot sheath (601) may have a T-shaped profile in cross-section, and the solid member may have a substantially cylindrical cross-section. A cross-section of the hollow shaft member (603) illustrates an outer diameter (604) and an outer diameter (605). The inner diameter (604) may be approximately 6″ in diameter. The annulus between the outer diameter (604) and the inner diameter (605) may be 1″ in thickness. Other dimensions for the inner diameter (604) and the outer diameter (605) may be possible as known in the art and suited for the ed to the purpose of sturdy trailer boot sheath (602).

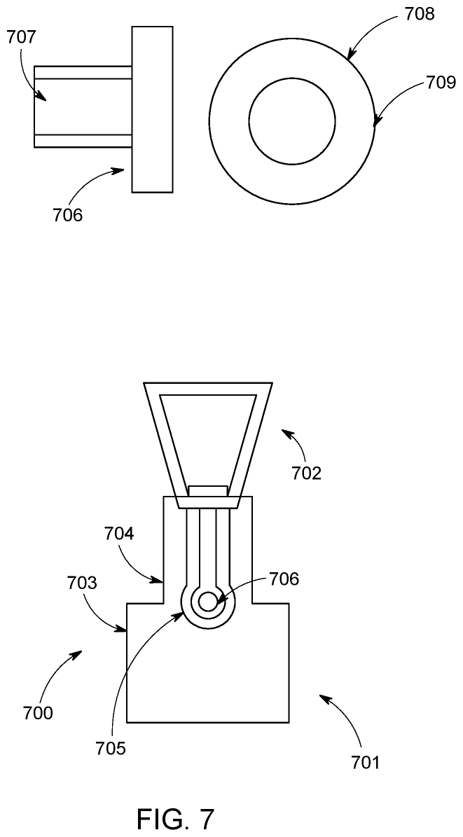

FIG. 7 is a cross-sectional view (700) of a trailer booth sheath (701). The trailer boot sheath (701) may be coupled to and enclose a trailer hitch attachment (702). The trailer hitch attachment (702) may be an “A-frame” form in an embodiment. The trailer booth sheath (701) may include a solid member (703) coupled to and enclosing a part of the trailer hitch attachment (702). The solid body (703) may include a mold fit (705) configured to receive a tongue (706) at an end of the trailer hitch attachment (702).

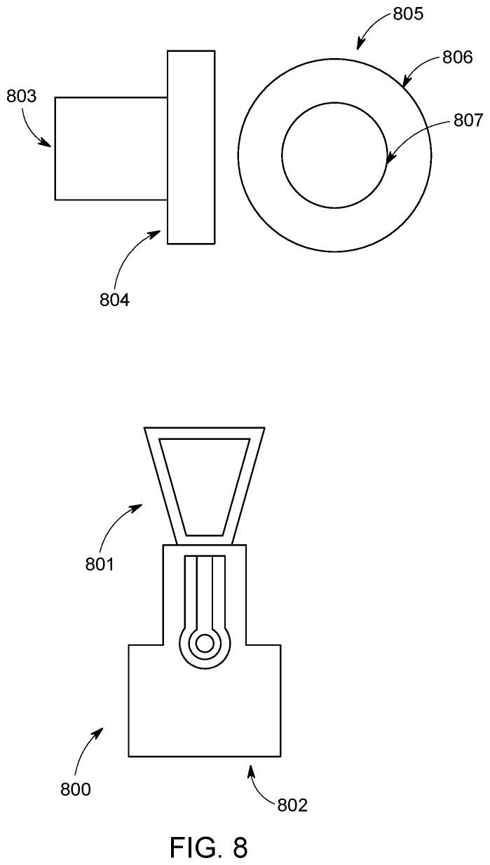

FIG. 8 is a cross-sectional view (800) of a trailer boot sheath (802) coupled to and enclosing an end of a trailer hitch attachment (801).

In an embodiment, a trailer booth sheath may include a substantially hollow shaft member (803), coupled to a solid member (804). In an embodiment, the entire length of the trailer boot sheath may be 16″, while the solid member (804) may be 12″. Other dimensions may be possible for other embodiments of a trailer boot sheath.

A cross-sectional view (805) of the hollow shaft member (803) illustrates a substantially cylindrical cross-section with an outer diameter of the trailer boot sheath (805) as 6.5″ and the size of the annulus formed between the outer diameter (805) and the inner diameter (807) may be 1″. The trailer booth sheath (805) may be formed of polyurethane foam or other structural elastic material known in the art and configured to form a cushioned body.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A trailer hitch protection device comprising:
a first portion covering a trailer hitch and extending outward from the trailer hitch to a location proximal to the trailer hitch;
a second portion abutting the first portion at the location proximal to the trailer hitch,
where the second portion is connected to the first portion at a substantially perpendicular angle between the first portion and the second portion, where the second portion comprises a solid body with a mold fit to receive the trailer hitch.
